(19) United States
(12) Patent Application Publication
(10) Pub. No.: US 2005/0112432 A1
(43) Pub. Date: May 26, 2005

(54) Method of plating metal leafs and metal membranes

(76) Inventors: Jonah Erlebacher, Chevy Chase, MD (US); Yi Ding, Baltimore, MD (US)

Correspondence Address: FLESHNER & KIM, LLP, P.O. BOX 221200, CHANTILLY, VA, 20153, US

(21) Appl. No.: 10/647,436

(22) Filed: Aug. 26, 2003

Related U.S. Application Data
(60) Provisional application No. 60/406,065, filed on Aug. 27, 2002.

(51) Int. Cl. H01M 4/86; H01M 8/10; H01M 4/90; H01M 4/92; B05D 5/12; H01M 4/88; B32B 15/08

(52) U.S. Cl. 429/30; 429/40; 429/33; 502/101; 427/115; 428/613; 428/672; 428/670; 428/673; 428/457

(57) ABSTRACT

A method of plating a nanoporous metal membrane is provided where at least a portion of the nanoporous metal member is freely supported on the surface of a metal plating solution containing at least one platable metal and the surface of the metal plating solution is contacted with a plating initiator. The nanoporous metal membrane is allowed to contact the plating solution for a period of time effective to plate at least a portion of the nanoporous metal membrane with the at least one platable metal. The plating initiator is preferably hydrazine.

This application claims priority to U.S. Provisional Appln. No. 60/406,065, filed on Aug. 27, 2002, which is incorporated by reference herein in its entirety.

### RELATED APPLICATION

This application is related to U.S. application Ser. No. 10/386,924, titled “Method of Forming Nanoporous Membranes,” filed on Mar. 13, 2003, which is incorporated by reference herein in its entirety.

### BACKGROUND OF THE INVENTION

1. Field of the Invention

The invention relates to methods for plating metal, and in particular to plating nanoporous metal membranes.

2. Background of the Related Art

Methods by which to form coatings are many and varied. The method used to coat a material depends, in part, on the composition of the desired coating composition and the composition of the material to be coated. Methods for forming metal coatings on various substrates include vapor deposition, electroplating and electroless plating.

Vapor deposition is carried out by heating a metal to form a metal vapor. The metal vapor is then allowed to condense onto the surface of a substrate, forming a metal coating thereon.

Electroplating involves placing a substrate to be plated in an electrolytic bath containing platable metal ions and passing a current between the object to be plated and the electrolytic bath containing metal ions. A coating including the platable metal ions is thereby formed on the substrate.

Electroless deposition may be carried out, for instance, by placing a substrate to be plated into a plating bath containing metal ions dissolved in a solvent, such as water. A chemical agent capable of causing the dissolved metal ions to precipitate out of solution, e.g., a reducing agent, is then introduced into the plating bath and a metal layer is formed on suitable substrates immersed in the metal ion/reducing agent solution.

U.S. Pat. No. 3,486,928 to Rhoda, et al, teaches a method that includes immersing a substrate metal into a plating bath containing ions of a plating metal and introducing a liquid reducing agent into the plating bath. Upon introduction of the liquid reducing agent, the plating metal precipitates out of solution and a portion of the plating metal coats the substrate metal.

One drawback to such processes, however, is that they frequently produce wasted plating metal. For instance, metal that precipitates out of solution may not be deposited on the substrate metal. Deposits of the plating metal may collect in the form of particulate dust in the plating bath or plate onto surfaces other then the substrate metal, such as surfaces of the container holding the plating bath. Traditional plating processes also make it difficult to control the thickness of the metal plated onto the substrate metal. Such imprecision makes it difficult or impossible to coat substrate metals with thin layers of a plating metal having relatively consistent thicknesses.

A second drawback to such processes is that they are unable to plate within the pores of highly porous substrates. When a porous substrate is immersed in the plating bath, metal ions from the solution enter the pores. When the reducing agent is added as a liquid, this causes plating of those metal ions within the pores, and thus metal ions are quickly depleted from the solution within the pores. As a result, plating only continues to occur on the outside surfaces of the porous material, creating a non-porous skin.

Catalytically active electrodes may be prepared by depositing a catalytically active metal, such as platinum, onto a substrate surface. For instance, carbon electrodes having catalytic activity are sometimes used in fuel cells. In fuel cells, it is desirable for all catalytic particles to be in electrical contact with an external electrical circuit. Fuel cell electrodes are typically formed by painting, spraying, or otherwise depositing a slurry containing platinum particles and a binder onto a porous carbon substrate. Such deposition techniques, however, are imprecise and many platinum particles remain suspended in the binder out of electrical contact to the substrate. To ensure that a sufficient quantity of catalyst is in electrical contact with the substrate substantial amounts of platinum are required. This frequently results in layers of catalytically active metal thicker than necessary for a particular use.

The above reference is incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Accordingly, it is an object of the present invention to provide methods of plating materials onto and into nanoporous metal membranes. Other objects, features and advantages of the present invention will be set forth in the detailed description of preferred embodiments that follows, and in part will be apparent from the description or may be learned by practice of the invention. These objects and advantages of the invention will be realized and attained by the compositions and methods particularly pointed out in the written description and claims hereof.

Another embodiment of the present invention is directed to an article which comprises a nanoporous metal membrane and a plating layer comprising at least one metal formed on at least a portion of the nanoporous metal membrane.

Another embodiment of the present invention is directed to a membrane electrode assembly which comprises a polymer electrolyte membrane and a nanoporous metal membrane adhered to at least one surface of the polymer electrolyte membrane, wherein the nanoporous metal membrane comprises a plating layer comprising at least one metal formed on at least a portion thereof.

Another object of the present invention is directed to a fuel cell which comprises a membrane electrode assembly, wherein the membrane electrode assembly comprises a polymer electrolyte membrane and a nanoporous metal membrane adhered to at least one surface of the polymer electrolyte membrane, wherein the nanoporous metal membrane comprises a plating layer comprising at least one metal formed on at least a portion thereof.

In accordance with these and other objectives, an embodiment of the present invention is directed to a method which comprises freely supporting a nanoporous metal membrane on a metal plating solution comprising at least one plating metal and contacting the metal plating solution with a reducing agent, thereby plating at least a portion of the nanoporous metal membrane with the at least one plating metal.

Another embodiment of the present invention is directed to a method which comprises contacting a nanoporous metal membrane with a metal plating solution comprising at least one plating metal and contacting the metal plating solution with a vapor phase reducing agent, thereby plating at least a portion of the nanoporous metal membrane with the at least one plating metal.

Another object of the invention is to provide plated nanoporous metal membranes and a method to create plated nanoporous metal membranes.

Another object of the invention is to provide plated nanoporous gold membranes a method to create plated nanoporous gold membranes.

Another object of the invention is to provide is to provide a nanoporous membrane plated with a catalytically active material, and a method to create a nanoporous membrane plated with a catalytically active material.

Another object of the invention is to provide a nanoporous membrane plated with a atomically thin layer of catalytically active material, and a method to create a nanoporous membrane plated with an atomically thin layer of catalytically active material.

Another object of the invention is to provide platinum plated nanoporous metal membranes and a method to a create platinum plated nanoporous metal membranes.

Another object of the invention is to provide a plating method which consumes a minimum amount of plating material.

Another object of the invention is to provide a plating method for fragile objects which does not subject the object to be plated to mechanical shocks and loads.

Another object of the invention is to provide plated electrodes and a method to create plated electrodes.

Another object of the invention is to provide catalytically active plated electrodes and a method to create catalytically active plated electrodes.

Another object of the invention is to provide electrodes for fuel cells and a method to create electrodes for fuel cells.

In order to achieve at least the above objects in whole or in part, a method is provided whereby a platable material is supported on a surface of a metal plating solution, and the surface of the metal plating solution is contacted with a plating initiator.

To further achieve at least the above objects in whole or in part, there is provided a method for plating metal by freely supporting the metal on the surface of a metal plating solution configured to plate the metal.

To further achieve at least the above objects in whole or in part, there is provided a method for plating a nanoporous metal membrane by supporting the nanoporous metal membrane on the surface of a metal plating solution and contacting the surface of the metal plating solution with a reducing agent.

To further achieve at least the above objects in whole or in part, there is provided a method for contacting a nanoporous membrane comprising a first metal with a metal plating solution capable of plating one or more metals, and introducing a vapor phase reducing agent, thereby plating at least a portion of said membrane with said one or more metals.

To further achieve at least the above objects in whole or in part, there is provided a nanoporous metal membrane comprising a first metal, and a plating layer comprising a second metal formed on at least a portion of said metal membrane.

To further achieve at least the above objects in whole or in part, there is provided a polymer electrolyte membrane, and a nanoporous metal membrane comprising a first metal adhered to the surface of said polymer electrolyte membrane, wherein said metal membrane comprises a plating layer comprising a second metal formed on at least a portion thereof.

To further achieve at least the above objects in whole or in part, there is provided a method for an atomically thin catalytic coating adhered to the surface of said nanoporous metal membrane.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 shows a rigid substrate with an adhered nanoporous metal membrane being inserted into a metal plating solution according to a preferred embodiment of the present invention.

FIG. 2 shows a nanoporous metal membrane supported on the surface of a metal plating solution and a plating initiator contacting the metal plating solution according to a preferred embodiment of the present invention.

FIG. 3 shows a nanoporous metal membrane being adhered to a cylindrical substrate according to a preferred embodiment of the present invention.

FIG. 4 shows a nanoporous metal membrane being de-adhered from a cylindrical substrate according to a preferred embodiment of the present invention.

FIG. 5-7 show photomicrographs at varying magnifications of a platinum coated nanoporous gold membrane made according to a preferred embodiment of the present invention.

FIG. 8 shows a polarization curve for a fuel cell made according to a preferred embodiment of the present invention.

### DETAILED DESCRIPTION OF PREFERRED EMBODIMENTS

A. Definitions

As used herein, the term “to de-alloy” is intended to mean that metal leaf has been contacted with a de-alloying medium for a sufficient amount of time to remove a metal constituent from the metal leaf and form a nanoporous metal membrane. Such nanoporous metal membranes include a porous structure exhibiting pore sizes on the order of a few nanometers to greater than 200 nm.

As used herein the term “metal leaf” is intended to mean a thin sheet of a metal alloy. Metal leaf typically has a thickness on the order of from less than 50 nm to greater than 500 nm. The alloy making up the metal leaf may include two or more metal constituents.

As used herein, the term “freely supporting” is intended to mean supporting at least a portion of a nanoporous metal membrane on the surface of liquid of a metal plating solution without the use of external solid substrates to support the portion.

As used herein, the term “nanoporous metal membrane” is intended to mean a membrane formed of at least one metal constituent and having a fine porous structure, generally measured in terms of nanometers. The term “nanoporous metal membrane” is intended, for instance, to include metal membranes have pore sizes of a few nanometers to up to 200 nm or greater. Additionally, nanoporous metal membranes is intended to include microporous metal membranes, having pores sizes of less than 2 nm, and mesoporous metal membranes, having pore sizes of 2 nm to 50 nm.

### B. Preferred Embodiments

A first preferred embodiment of the present invention is directed to an article which comprises a nanoporous metal membrane and a plating layer comprising at least one metal on at least a portion of the nanoporous metal membrane.

The nanoporous metal membrane according to the present invention comprises at least one metal constituent. In certain preferred embodiments of the present invention, the nanoporous metal membrane includes gold, nickel, copper, or the like. Preferably, the nanoporous metal membrane includes gold. More preferably, the nanoporous metal membrane consists of gold.

According to one embodiment of the present invention, the nanoporous metal membrane preferably has a thickness of from about 50 nm to about 500 nm, more preferably about 100 nm to about 300 nm and even more preferably about 150 nm to about 250 nm. In certain preferred embodiments of the present, the nanoporous metal membrane has a thickness of about 250 nm, more preferably about 100 nm. According to the methods of the present invention, even very fragile nanoporous metal membranes, such as ones less than 50 nm thick, may be plated.

The nanoporous metal membranes according to the present invention preferably have pore sizes ranging from about 3 nm to about 25 nm, more preferably about 5 nm to about 15 nm and still more preferably about 10 to about 15 nm. Most preferably the nanoporous metal membranes have a pore size of about 15 nm.

In another preferred embodiment of the present invention, the nanoporous metal membrane has a pore size of from about 25 nm to about 250 nm, more preferably about 50 nm to about 150 nm and still more preferably about 75 nm to about 120 nm.

The nanoporous metal membranes according to the present invention preferably have ligaments of about 2 nm to about 25 nm in diameter, more preferably about 5 nm to about 20 nm and still more preferably about 10 nm to about 15 nm. Most preferably the ligaments are about 15 nm.

The nanoporous metal membranes according to the present invention preferably exhibit high surface areas. For example, surface areas on the order of about 10 m²/g are preferred.

According to a preferred embodiment of the present invention, the nanoporous metal membrane may be prepared by de-alloying metal leaf. Such nanoporous metal membranes may be prepared, for instance, by contacting metal leaf with a de-alloying medium, such as concentrated acid, for a time effective to remove at least one of the metal constituents of the metal leaf Certain preferred methods for forming nanoporous metal membranes are disclosed in U.S. patent application Ser. No. 10/386,924, titled “Method of Forming Nanoporous Membranes,” filed on Mar. 13, 2003, which is incorporated by reference herein in its entirety. Other preferred methods for forming porous metal membranes are disclosed in U.S. Pat. No. 4,977,038, which is incorporated by reference herein in its entirety.

According to the present invention, a plating layer is formed on at least a portion of the nanoporous metal membrane. The plating layer includes at least one metal constituent. The metal constituent may be any metal capable of plating onto the nanoporous metal membrane. Non-limiting examples of suitable metals include platinum, iridium, rhodium, ruthenium, palladium, nickel, cobalt, silver. Such metals may be used alone or in combinations of two or more. In certain preferred embodiments of the present invention, the plating layer includes at least one precious metal, such as platinum. In other preferred embodiments of the present invention, the plating layer includes at least two metals.

The plating layer may be formed to any desired thickness achievable by the deposition method employed. Preferably, the plating layer has a thickness of about 1 nm to about 5 nm, more preferably about 2 nm to about 4 nm and most preferably about 3 nm. In still other preferred embodiments of the present invention, the plating layer has a thickness of at least 1 nm, more preferably at least 2 nm, even more preferably at least 3 nm, still more preferably at least 4 nm and most preferably at least 5 nm. In particularly preferred embodiments of the present invention, the plating layer has a thickness of from 1 to about 5 atoms of the plating metal(s).

According to the present invention, the metal plating layer preferably has a plating density less than about 0.2 mg/cm², more preferably less than about 0.1 mg/cm², still more preferably less than about 0.05 mg/cm², even still more preferably 0.025 mg/cm² and most preferably less than about 0.005 mg/cm².

Another preferred embodiment of the present invention is directed to a method which comprises freely supporting a nanoporous metal membrane on a metal plating solution comprising at least one plating metal; and contacting the metal plating solution with a reducing agent, thereby plating at least a portion of the nanoporous metal membrane with the at least one plating metal.

Suitable metal plating solutions according to the methods of the present invention include chemical baths configured to plate at least one metal, including aqueous and non-aqueous baths. In certain preferred embodiments, the metal plating solution contains at least two plating metals. Non-limiting examples of metal plating solutions include, but are not limited to, platinum, rhodium, iridium, ruthenium, silver, nickel, and cobalt plating solutions. Examples of suitable metal plating solutions are disclosed, for instance, in U.S. Pat. Nos. 3,486,928 and 6,391,477, both of which are incorporated herein by reference in their entirety. Suitable compositions of metal plating solutions may be determined empirically by one having ordinary skill in the art using methods and techniques known in the art.

The metal plating solutions of the present invention may contain additives, such as buffers, stabilizers and the like. For instance, an acid, such as hydrochloric acid, or a base, such as NaOH, may be used to adjust the pH of the metal plating solution. Such acids and bases may be either concentrated or dilute. Non-limiting examples of suitable stabilizers include, but are not limited to ethylamine, ethylene diamine tetraacetic acid salts, quinoline, sulfamate, for instance provided as sulfamic acid, and combinations thereof. Suitable pH ranges, stabilizers and the like may be determined empirically by one having ordinary skill in the art using methods and techniques known in the art.

Metal plating is carried out for a time effective to plate at least a portion of the nanoporous metal membrane with at least one plating metal. Preferably, plating is carried out for a period of about 15 minutes to about 5 hours. Suitable times depend, among other things, on the amount of deposition desired and the plating solution employed. Such plating times may be determined empirically by one having ordinary skill in the art using methods and techniques known in the art.

According to a preferred embodiment of the present invention, a platinum plating layer is formed on at least a portion of a nanoporous metal membrane using a metal plating solution containing Na₂Pt(OH)₆. Platinum plating solutions preferably contain about 2 g/l to about 20 g/l of Na₂Pt(OH)₆. Suitable metal plating solutions may be prepared, for instance, by forming an aqueous solution containing dihydrogen hexachloroplatinate(IV) and sodium hydroxide. Alternatively, platinum plating solutions may be prepared by dissolving diammineplatinum(II) nitrite in a sodium hyrdoxide solution. According to certain preferred embodiments of the present invention, such platinum plating solutions have a pH of about 9 to about 10.

In another preferred embodiment of the present invention, a cobalt plating layer is formed on at least a portion of a nanoporous solution. Suitable cobalt plating solutions may be prepared, for instance, by forming an aqueous mixture containing CoCl₂.6H₂O, Na₃C₆H₅O₇.2H₂O, NH₄Cl, NaOH and concentrated ammonia. It is preferred that the pH of such cobalt plating solutions is adjusted to approximately 12.5 prior to plating the nanoporous metal membrane.

According to another preferred embodiment of the present invention, a silver plating layer is formed on at least a portion of a nanoporous metal membrane. Silver plating solutions may be prepared, for instance, by forming an aqueous solution containing silver nitrate, disodium EDTA and concentrated ammonia.

Metal plating solutions according to the methods of the present invention may be used at ambient temperature, above ambient temperature or below ambient temperature. In alternative embodiments of the present invention, the metal plating solution may maintained at different temperatures before and during metal plating. Suitable temperatures may be determined empirically by one having ordinary skill in the art using methods and techniques known in the art.

According to the methods of the present invention, electroless metal deposition is preferred. However, if this is not desired, electrolytic deposition may be employed.

According to the methods of the present invention, any reducing agent capable of initiating metal deposition may be employed. Such reducing agents may be used alone or in combination. The particular reducing agent(s) used will depend, in part, on the composition of the metal plating bath and may be determined empirically by one having ordinary skill in the art using methods and techniques known in the art. Preferably, the reducing agent is hydrazine.

In certain preferred embodiments of the present invention, at least a portion of the nanoporous metal membrane is freely supported on the metal plating solution before, during and/or after metal plating. In certain other preferred embodiments of the present invention, at least a portion of the nanoporous metal membrane is supported on a substrate before, during and/or after metal plating. In particularly preferred embodiments of the present invention, the nanoporous metal membrane is entirely freely supported on the metal plating solution before, during and/or after metal plating.

According to such embodiments of the present invention, the substrate is in the form of a planar sheet or other non-planar substrate suitable to support at least a portion of the nanoporous metal membrane. Non-limiting examples of such planar substrates include circular, square, rectangular, polygonal and the like. Non-planar substrates include, but are not limited to, substrates that are convex, concave, spherical, cylindrical, rippled, and the like. Preferably, the substrate is cylindrical or rod shaped.

The substrate may be made from a variety of materials, as long as the material is capable of supporting at least a portion of the nanoporous metal membrane. For example, the substrate may be made from materials such as glass, ceramic, metals, graphite, rubber, nylon and other polymeric materials. Any material may function as the supportive substrate as long as the nanoporous metal membrane may be adhered to and de-adhered from the substrate. Preferably, the substrate is unreactive with and non-soluble in the metal plating solution.

In certain preferred embodiments of the present invention, the substrate is smooth and nonporous, or otherwise resistant to absorbing the metal plating solution or other liquids. According to one embodiment of the present invention, the supportive substrate may be treated with materials that affect adhering and de-adhering of the nanoporous metal membrane, such as release agents, agents that reduce or dissipate electrostatic charge and other agents that increase or decrease adherence of the nanoporous metal membrane to the substrate. In other preferred embodiments of the present invention, the substrate may be polished or ground prior to use in order, for instance, to remove surface irregularities. While not wishing to be bound by theory, it is thought that such surface irregularities might adversely interact with the nanoporous metal membrane, for instance, by causing punctures of tears therein.

In a preferred embodiment of the present invention, at least a portion of the nanoporous metal membrane is de-adhered from the substrate as the substrate is brought into contact with the metal plating solution. For instance, the nanoporous metal membrane may be de-adhered from the substrate by inserting the substrate into the metal plating solution, whereby the nanoporous metal membrane detaches from the substrate as the substrate enters the metal plating solution. After contacting the nanoporous metal membrane with the metal plating solution for a predetermined amount of time, the nanoporous metal membrane is preferably re-adhered to the substrate by withdrawing the substrate from the metal plating solution.

In another preferred embodiment of the present invention, the nanoporous metal membrane is selectively plated. That is, a portion of the nanoporous metal membrane is plated with at least one metal and at least another portion of the nanoporous metal membrane is not plated. This may be carried out, for instance, by selectively applying at least one compound that adheres to the surface of the nanoporous metal membrane and results in areas having different chemical characteristics. Such compounds may be applied to predetermined portions of the nanoporous metal membrane prior to metal plating, resulting in a patterned metal deposition.

One class of such chemicals includes organic molecules that are terminated in a thiol (—SH) group. Alkane thiols, for instance, react with gold to form a dense molecular skin that may be used to modify the properties of the gold surface. The application of an alkane thiol (CH₃(CH₂)ₓ—SH), for instance, will turn the normally hydrophilic gold surface to a hydrophobic one, thus altering the hydrophobicity/hydrophilicity of the gold. Preferred thiols include, but are not limited to, CH₃(CH₂)₁₁—SH and CH₃(CH₂)₁₈—SH.

The alkanethiols may be spatially located on the surface of a nanoporous metal membrane by locally dropping or otherwise dispersing a solution of alkanethiol in a solvent, such as ethanol, onto predetermined portions of a nanoporous metal membrane. Such compounds may also be applied without a solvent. Preferably, the nanoporous metal membrane is floating on water during deposition of the alkanethiol. Other methods, including inkjet patterning and soft lithography, may be used to locally pattern the nanoporous metal membrane with compounds, including alkanethiols. The result is that the porous membrane becomes partially hydrophilic, and partially hydrophobic. When such a patterned nanoporous metal membrane is floated upon a plating solution, the plating solution will be wicked into the pores only where no alkanethiol is present. When the plating solution is exposed to a reducing agent, such as a hydrazine atmosphere, plating will proceed only in the hydrophilic (i.e., no alkanethiol) regions of the membrane. In this way, a nanoporous metal membrane may be selectively plated.

The invention will now be described by reference to the figures in which like reference numbers refer to like elements.

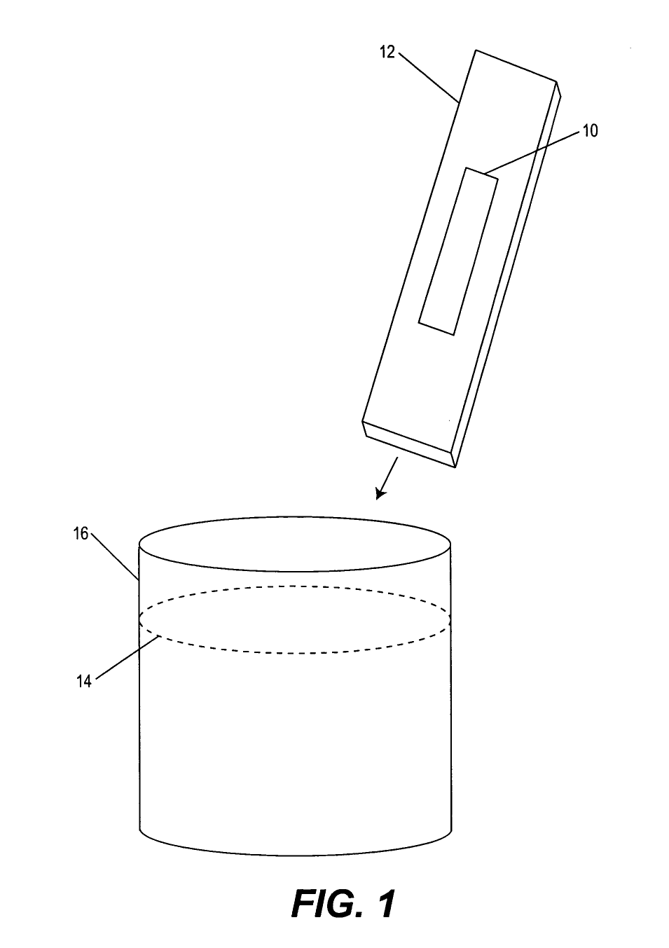

A preferred embodiment of the present invention is shown in FIG. 1 where a nanoporous gold membrane 10 is shown adhered to a supportive substrate 12. The nanoporous gold membrane 10 is adhered to the supportive substrate 12 to simplify handling of the nanoporous gold membrane 10 during plating. Although FIG. 1 shows a planar supportive substrate, it is sometimes preferred for the supportive substrate to be cylindrical or rod shaped. Additionally, any shape of supportive substrate which facilitates adhering and de-adhering the platable material to and from the supportive substrate may be used.

As shown in FIG. 1, the supportive substrate 12 with the nanoporous gold membrane 10 adhered thereto is inserted into a metal plating solution 14 held in a container 16. As the supportive substrate 12 is inserted into the metal plating solution 14, the nanoporous gold membrane 10 de-adheres from the supportive substrate 12. The supportive substrate 12 is preferably inserted into the metal plating solution 14 at an angle to facilitate the nanoporous gold membrane's 10 transition from being supported by the supportive substrate 12 to being supported upon the surface of the metal plating solution 14.

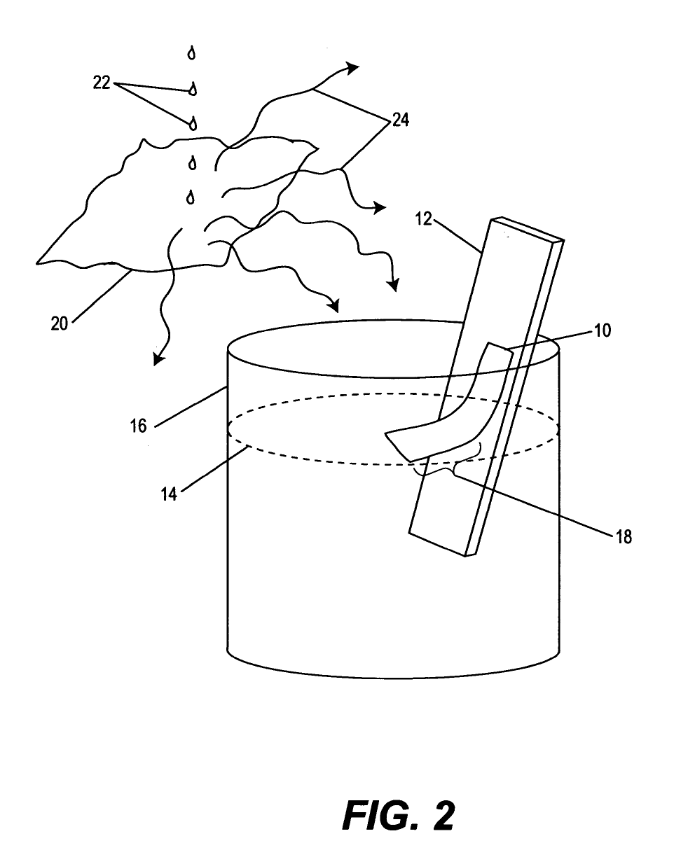

Referring to FIG. 2, the supportive substrate 12 is shown inserted into the metal plating solution 14 with a de-adhered section 18 of the nanoporous gold membrane 10 separated from the supportive substrate 12 and supported on the surface of the metal plating solution 14. Because the de-adhered section 18 is supported on the surface of the metal plating solution 14 during the plating process, the entire length of the nanoporous gold membrane 10 is supported regardless of whether it is in contact with the supportive substrate 12. Additionally, by de-adhering the nanoporous gold membrane 10 from the supportive substrate 12 by inserting the supportive substrate 12 into the metal plating solution 14, the nanoporous gold membrane 10 is transferred to the surface of the metal plating solution 14 with minimal mechanical disturbance.

Because the de-adhered section 18 of the nanoporous gold membrane 10 is supported upon the surface of the metal plating solution 14, the nanoporous gold membrane 10 is supported while it is plated. Accordingly, the de-adhered section 18 of the nanoporous gold membrane 10 is not supported by the solid substrate 12 during the plating step, but instead is freely supported on the plating solution's surface 14. It is also possible to completely de-adhere the nanoporous gold membrane 10 from the substrate such that the nanoporous gold membrane 10 is entirely freely supported on the plating solution's surface 14.

FIG. 2 also shows blotting paper 20 proximate to the container 16 upon which a reducing agent 22 is applied to produce fumes 24 of reducing agent 22 that diffuse from the blotting paper 20 toward the surface of the metal plating solution 14. While FIG. 2 shows a blotting paper 20 receiving a liquid reducing agent 22, any system which allows a reducing agent in gaseous, vapor, or atomized form to contact the surface of the metal plating solution 14 may be employed according to the methods of the present invention. Thus, any method of introducing a reducing agent, or other plating initiator, which allows the plating initiator to interact with the surface of the metal plating solution may be employed according to the methods of the present invention. Accordingly, some embodiments may apply a reducing agent in gaseous form directly to the surface of the metal plating solution. Other embodiments may spray a fine mist of a reducing agent over the surface of the metal plating solution.

In other preferred embodiments of the present invention, the nanoporous metal membrane is freely supported on the surface of the metal plating solution and a liquid reducing agent is placed near the plating bath. The liquid reducing agent may be, for instance, adsorbed on a paper support or placed in a container, such as a glass beaker. The plating bath and reducing agent are then enclosed, for instance by placing a larger container over the plating bath and reducing agent, thereby allowing the reducing agent to diffuse into the enclosed volume and initiate plating. Such containers may be formed of any material that does not adversely affect the plating process, such as plastic, rubber, glass, metal and the like. Suitable materials may be determined empirically by one having ordinary skill in the art using methods and techniques known in the art.

In other preferred embodiments of the present invention, an enclosure, such as one of plastic, rubber, metal, glass or the like, having an opening in the surface thereof and of sufficient dimensions to enclose the plating bath is placed over the plating bath. A vapor phase reducing agent is then introduced into the enclosed volume by placing a material, such as cloth or paper, having a reducing agent adsorbed thereon over the opening and allowing the reducing agent to diffuse into the enclosed volume, thereby initiating plating. In certain preferred embodiments of the present invention, 3 to 5 drops of hydrazine are used. Other suitable arrangements may be determined empirically by one having ordinary skill in the art using methods and techniques known in the art.

According to methods of the present invention employing a vapor phase reducing agent, the reducing agent may be introduced by any method capable of introducing the reducing agent in the vapor phase, such as those known to one having ordinary skill in the art. In still other preferred embodiments of the present, the reducing agent is introduced into the plating bath as a liquid.

Once a sufficient amount of reducing agent 22 has interacted with the metal plating solution 14 to plate the nanoporous gold membrane 10 to the desired thickness, the nanoporous gold membrane 10 is a re-adhered to the supportive substrate 12 by reversing the process of inserting the supportive substrate 12 into the metal plating solution 14. Subsequent steps, such as washing, may be carried out in a similar manner by inserting the supportive substrate 12 into a bath and de-adhering the nanoporous gold membrane 10 onto the surface of the bath. Additionally, the nanoporous gold membrane 10 may be transferred to another substrate for further processing.

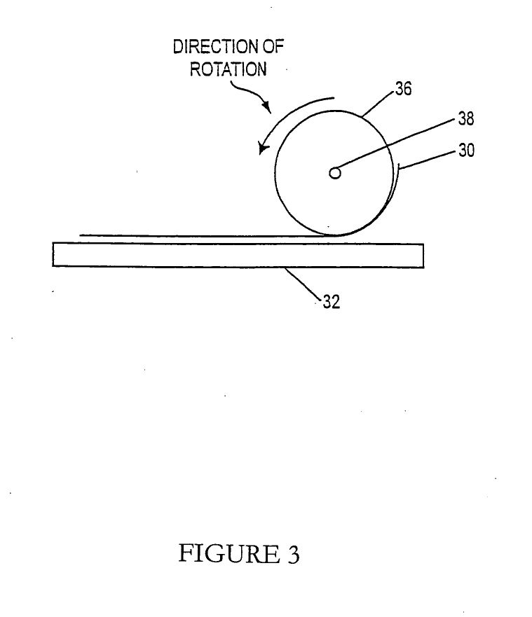

According to another preferred embodiment of the present invention, nanoporous metal membrane is plated using a graphite rod as a substrate. As shown in FIG. 3, a nanoporous metal membrane 30 is adhered to a graphite rod 36 by rolling the graphite rod 36 over the nanoporous metal membrane 30. Preferably, the length of the graphite rod 36 is greater than the width of the nanoporous metal membrane 30, so that the nanoporous metal membrane 30 does not hang over the ends of the graphite rod 30. In certain preferred embodiments of the present invention, the graphite rod 36 has a diameter of about 2 inches and a length of about 4 inches. Preferably, the graphite rod is wetted and at least partially dried prior to use.

As shown in FIG. 3, the graphite rod has arms 38 extending from each end thereof. The arms 38 may be formed as a continuous piece of the rod 36, for instance by turning on a lathe to form a monolithic body, or may be inserted into or otherwise attached to the rod 36, for instance by adhesive bonding or other methods known in the art. Screws or dowels may be attached to the rod 36, for instance, thereby forming arms 38. The arms 38 may be formed of the same material as the rod 36 or of a different material than the rod 36. Examples of suitable materials include, but are not limited to, metals, plastics, teflon, ceramics, other polymeric materials and the like. In a preferred embodiment of the present invention, the arms 38 are supported on the edge of a container holding a liquid, such as water or a metal plating solution Such an arrangement allows for easy adhering and de-adhering of the nanoporous metal membrane 30 to and from the graphite rod 36 during the metal plating process by simply rolling the arms along the edges of the bath.

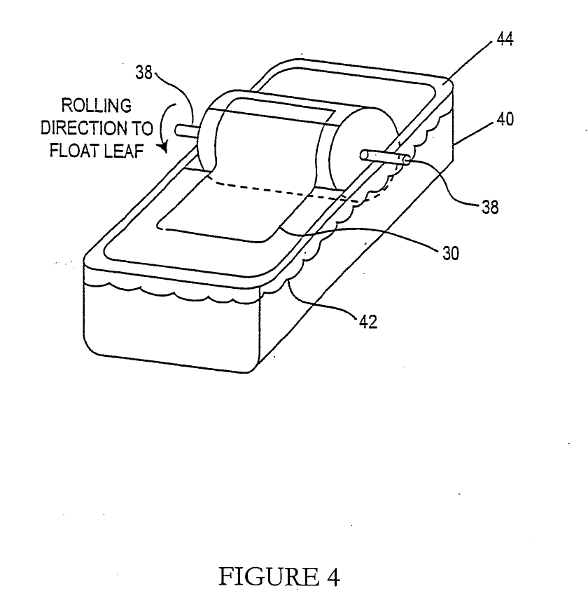

Preferably, the nanoporous metal membrane is floated on water prior to metal plating. This allows any wrinkles in the nanoporous metal membrane to be smoothed out and, additionally, forms a water layer on the nanoporous metal membrane 30. According to such embodiments, as shown in FIG. 4, a container 40 having dimensions such that arms 38 rest on the edge 44 of the container 40 is filled with water. Preferably, the container is filled with water to an extent such that the rod 36 is submerged almost up to the bottom of the arms 38. The rod 36 is then rolled along the length of the container 40 and the nanoporous metal membrane 30 is de-adhered from the graphite rod 36 and is floated on the surface of the water 42. The rod 36 may either be left on the edge of the container 44 or removed therefrom.

The nanoporous metal membrane 36 may be re-adhered to the rod by rolling the rod 36 along the edge 44 of the container 40. Preferably, the rod 36 is rolled in the opposite direction along the edge 44 of the container than it was rolled to de-adhere the nanoporous metal membrane 30. If the graphite rod 36 was removed after de-adhering the nanoporous metal membrane, it is repositioned on the edge 44 of the container 40 prior to re-adhering the nanoporous metal membrane 30 to the graphite rod 36.

While FIG. 4 illustrates an embodiment wherein the container is filled nearly to the top with water, the container need only be filled to such a level that at least a portion of the graphite rod contacts the water, thereby allowing the nanoporous metal membrane to be de-adhered from the graphite rod. Additionally, the dimensions of the container are dependent upon the dimensions of the rod and may be determined empirically by one having ordinary skill in the art. While the container shown in FIG. 4 is rectangular in shape, other geometries, such as square, may be used. Such geometries may readily be determined empirically by one having ordinary skill in the art. Preferably, the container is glass.

According to a preferred embodiment of the present invention, the wetted nanoporous metal membrane is then transferred to a container holding a plating solution, in a manner similar to the described above with respect to the water bath. The plating solution includes at least one plating metal. The nanoporous metal membrane is allowed to contact the plating solution for a time effective to plate at least a portion of the nanoporous metal membrane with the at least one plating metal.

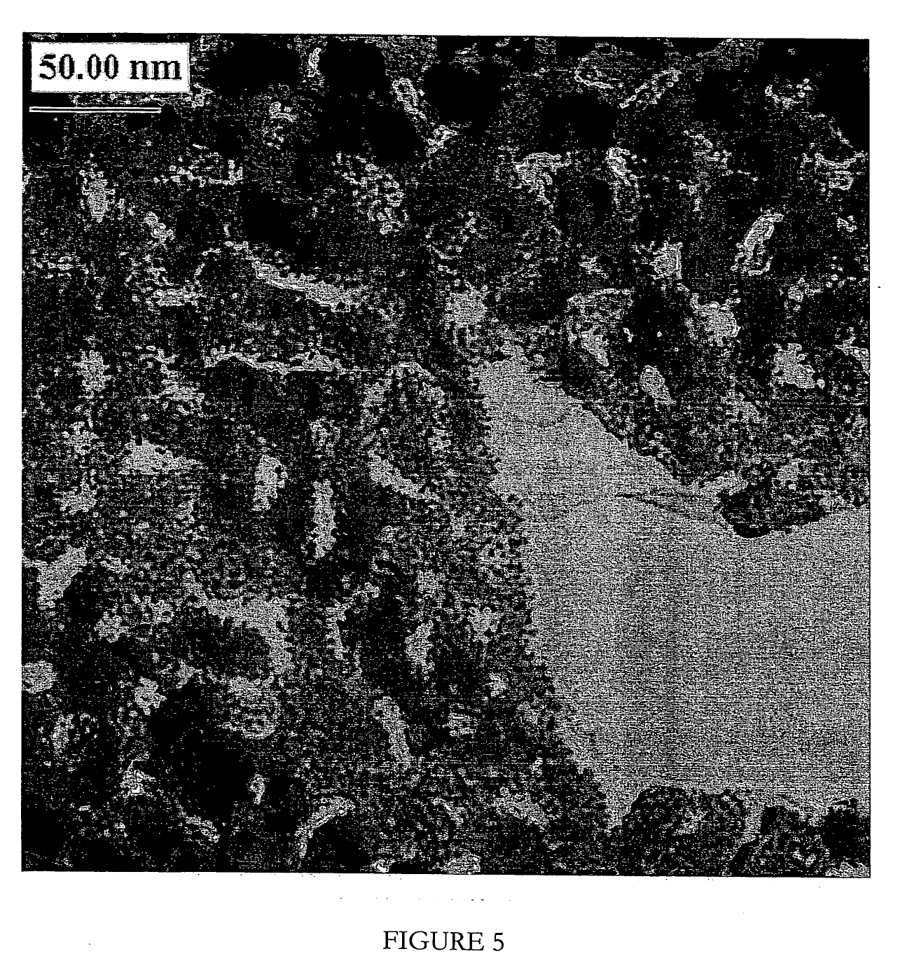

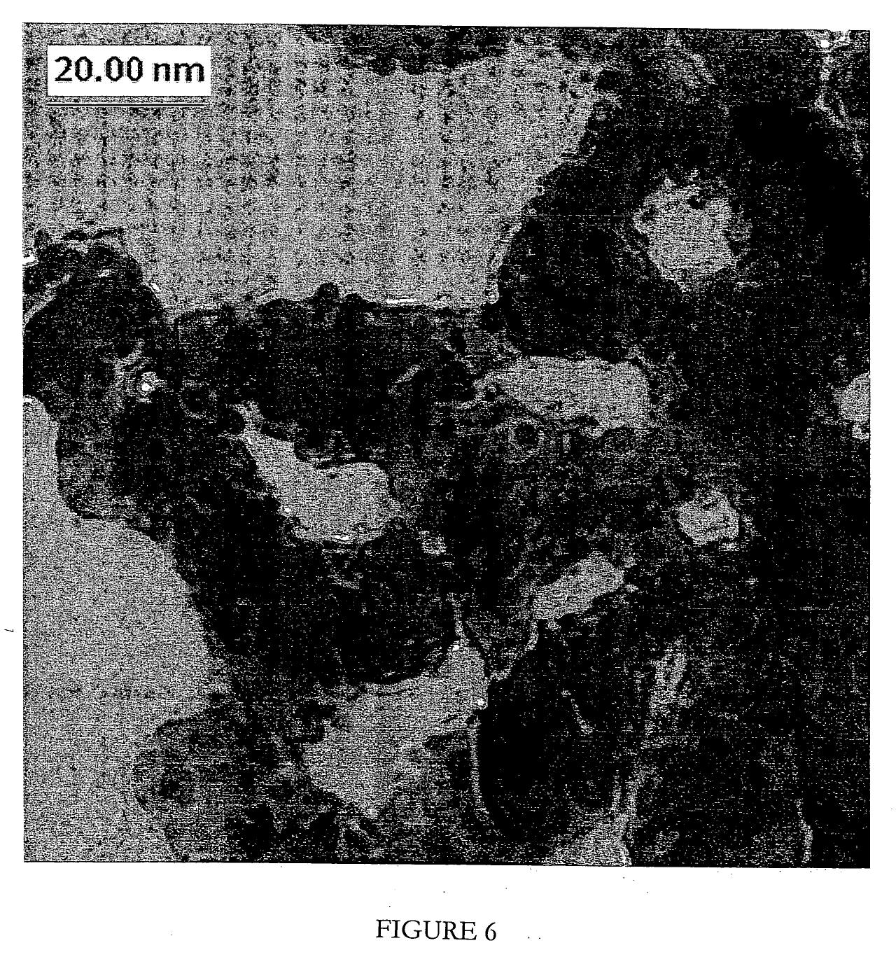

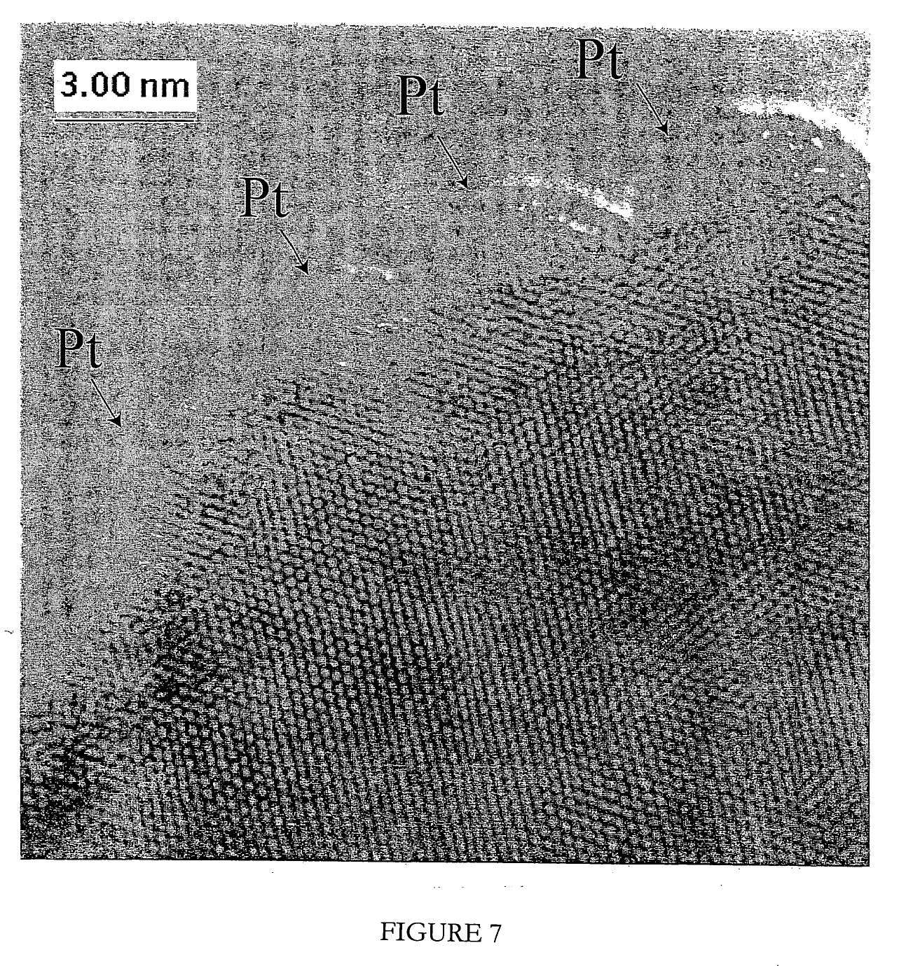

FIGS. 5-7 show photomicrographs at varying magnification of a platinum coated nanoporous gold membrane made according to preferred embodiments of the present invention. Plating was carried out for about 192 minutes. As can be seen in FIG. 7, the platinum plating layer is continuous and includes hemispherical platinum particles. The platinum particles have a maximum thickness of about 3 nm.

In the case where a nanoporous metal membrane is plated with a catalytically active metal, such as platinum, the catalytically active nanoporous membrane may be used as an electrode structure. For instance, the catalytically active porous metal membrane may be affixed to one or both sides of a polymer electrolyte membrane, such as perfluorinated sulphonic acid, polystyrene sulfonate, or other similar materials. For example, after coating a nanoporous gold membrane with platinum, the platinum plated nanoporous membrane may be affixed to each side of an electrolyte sheet, such as Nafion (manufactured by DuPont), to form a membrane electrode assembly. Such membrane electrode assemblies may be used, for instance, in a fuel cell. Preferably, the electrolyte sheet is Nafion 112.

According to certain preferred embodiments of the present invention, a platinum plated nanoporous metal membrane, e.g, a nanoporous gold membrane, may be adhered to a Nafion sheet by placing the Nafion sheet on a nylon roller, and as discussed above for handling the nanoporous gold membrane, transferring the nanoporous metal membrane from the solution to the Nafion on the roller. A nanoporous metal membrane may be applied to the other side of the Nafion sheet in a similar manner. Such a method may be used with solid or semi-solid electrolytes. The resulting structure may be dried at ambient temperature or an elevated temperature prior to use. Preferably, the structure is air dried followed by heating at an elevated temperature, for instance for about 2 minutes at 140° C. Suitable drying times and conditions may be determined empirically by one having ordinary skill in the art.

Another preferred embodiment of the present invention is directed to a fuel cell which comprises a membrane electrode assembly, wherein the membrane electrode assembly includes a polymer electrolyte membrane and a nanoporous metal membrane adhered to at least one surface of the polymer electrolyte membrane and, further, wherein the nanoporous metal membrane includes a plating layer including at least one metal formed on at least a portion of the nanoporous metal membrane. Such plated nanoporous metal membranes may be made, for instance, according to the methods of the present invention.

### EXAMPLES

The following examples are illustrative, but not limiting, of the present invention. Other suitable modifications and adaptations are of the variety normally encountered by those skilled in the art, and are fully within the spirit and scope of the present invention. It will be understood to those of ordinary skill in the art that the methods of the present invention can be carried out with a wide and equivalent range of conditions, formulations and other parameters without departing from the scope of the invention or any embodiments thereof.

### Example 1

In this example, nanoporous gold membrane was plated with platinum. The platinum plating bath was prepared by mixing 2.2 g of H₂PtCl₆ and 2.2 g of NaOH in 200 ml of distilled water. The solution was stirred at 80° C. for about 15 minutes. The initial pH of the solution was about 12.1 and was adjusted to about 9.6 by the addition of 0.1 M HCL. The final volume of the plating solution was about 420 ml.

A nanoporous gold membrane was transferred to a nylon rod having arms extending from the ends thereof by rolling the rod over the nanoporous gold membrane. The nanoporous gold membrane was then unrolled onto a water bath by rolling the arms of the nylon rod along the edges of plating bath container. After about 20 minutes, the nanoporous metal membrane was removed from the water bath using the nylon rod and was transferred to the platinum plating solution.

Aluminum foil was placed around the plating bath so as to provide an opening in the foil over the bath. A paper cloth was placed over the opening in the aluminum foil and 4 drops of hydrazine were dropped onto the paper. After about two minutes, the color of the nanoporous metal membrane had changed and it was removed from the plating bath using a nylon rod. The platinum plated nanoporous metal membrane was then rinsed in a water bath by unrolling it onto surface of the water bath.

### Example 2

In this example, a fuel cell containing a membrane electrode assembly was prepared. Platinum plated nanoporous gold membranes were prepared as described in Example 1, with plating carried out for about 2 hours. The platinum plated nanoporous gold membranes according to the present example had platinum loading of about 0.04 mg/cm².

A Nafion sheet was adhered to a roller having arms extending from the ends thereof. The Nafion sheet was adhered to a platinum plated nanoporous gold membrane by rolling the arms of the roller along the edges of a water bath having a first platinum plated nanoporous gold membrane floating therein. The Nafion/platinum plated nanoporous gold membrane structure was removed from the water bath. A second piece of platinum plated nanoporous gold membrane was placed in the water bath. The Nafion/platinum plated nanoporous gold membrane structure was adhered to a roller with the uncoated surface of the Nafion sheet exposed. A second piece of platinum plated nanoporous gold membrane was adhered to the exposed surface of the Nafion sheet. The first and second platinum plated nanoporous gold membranes were smaller in area than the Nafion sheet. Following air drying, the assembly was dried in a furnace for about two minutes at 140° C.

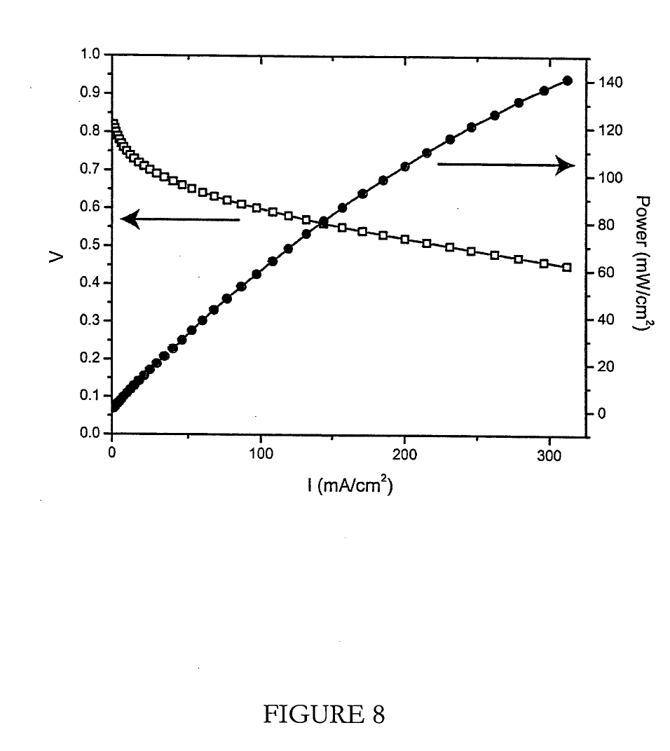

To construct the fuel cell, the dried assembly was sandwiched between two sheets of Toray carbon paper, and this structure was in turn sandwiched between two graphite plates on which gas flow channels had been machined into an area of a 1 cm². Cell performance was measured at room temperature and ambient pressure, feeding the cell with H₂ and O₂ passed through a bubbler. A polarization curve for the cell is shown in FIG. 8. The curve is characterized by an open circuit voltage (OCV) near 0.9 V, a short circuit current (SCC) near 0.5 A/cm² and a maximum power density (MPD) greater than 0.14 W/cm².

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art.

1. An article which comprises:
a nanoporous metal membrane; and
a plating layer comprising at least one metal constituent formed on at least a portion of said nanoporous metal membrane.

2. The article according to claim 1, wherein said plating layer has a thickness of about 1 nm to about 5 nm.

3. The article according to claim 1, wherein said nanoporous metal membrane comprises gold.

4. The article according to claim 1, wherein said plating layer comprises at least one precious metal.

5. The article according to claim 1, wherein said plating layer comprises platinum.

6. The article according to claim 1, wherein said plating layer comprises at least one member selected from the group consisting of platinum, iridium, rhodium, ruthenium, palladium, cobalt and silver.

7. The article according to claim 1, wherein said plating layer comprises at least two metals.

8. The article according to claim 1, wherein said plating layer has a loading density of less than about 0.1 mg/cm².

9. The article according to claim 1, wherein said plating layer has a loading density of less than about 0.05 mg/cm².

10. The article according to claim 1, wherein said plating layer has a loading density of less than about 0.025 mg/cm².

11. The article according to claim 1, wherein said plating layer has a loading density of about 0.005 mg/cm².

12. The article according to claim 1, wherein said nanoporous metal membrane has a thickness of about 100 nm.

13. The article according to claim 1, wherein said nanoporous metal membrane has a thickness of less than about 500 nm.

14. The article according to claim 1, wherein said nanoporous metal membrane has a thickness of less than about 250 nm.

15. The article according to claim 1, wherein said nanoporous metal membrane has a thickness of less than about 100 nm.

16. A membrane electrode assembly which comprises:
a polymer electrolyte membrane; and
a nanoporous metal membrane adhered to at least one surface of said polymer electrolyte membrane, wherein said nanoporous metal membrane comprises a plating layer comprising at least one metal formed on at least a portion thereof.

17. The membrane electrode assembly according to claim 16, wherein said polymer electrolyte membrane comprises a member selected from the group consisting of perfluorinated sulphonic acids and polystyrene sulfonate.

18. The membrane electrode assembly according to claim 16, wherein said nanoporous metal membrane comprises gold.

19. The membrane electrode assembly according to claim 16, wherein said plating layer comprises at least one precious metal.

20. The membrane electrode assembly according to claim 16, wherein said plating layer comprises platinum.

21. The membrane electrode assembly according to claim 16, wherein said plating layer comprises at least one member selected from the group consisting of platinum, iridium, rhodium, ruthenium, palladium, cobalt and silver.

22. The membrane electrode assembly according to claim 16, wherein said plating layer has a thickness of about 1 nm to about 5 nm.

23. The membrane electrode assembly according to claim 16, wherein said plating layer has a loading density of less than about 0.1 mg/cm².

24. The membrane electrode assembly according to claim 16, wherein said plating layer has a loading density of less than about 0.05 mg/cm².

25. The membrane electrode assembly according to claim 16, wherein said plating layer has a loading density of less than about 0.025 mg/cm².

26. The membrane electrode assembly according to claim 16, wherein said plating layer has a loading density of about 0.005 mg/cm².

27. The membrane electrode assembly according to claim 16, wherein said nanoporous metal membrane has a thickness of about 100 nm.

28. The membrane electrode assembly according to claim 16, wherein said nanoporous metal membrane has a thickness less about 500 nm.

29. The membrane electrode assembly according to claim 16, wherein said nanoporous metal membrane has a thickness of less than about 250 nm.

30. The membrane electrode assembly according to claim 16, wherein said nanoporous metal membrane has a thickness of less than about 100 nm.

31. A fuel cell which comprises a membrane electrode assembly, wherein said membrane electrode assembly comprises a polymer electrolyte membrane; and a nanoporous metal membrane adhered to at least one surface of said polymer electrolyte membrane, and further wherein said nanoporous metal membrane comprises a plating layer comprising at least one metal formed on at least a portion thereof.

32. The fuel cell according to claim 31, wherein said polymer electrolyte membrane comprises a member selected from the group consisting of perfluorinated sulphonic acids and polystyrene sulfonate.

33. The fuel cell according to claim 31, wherein said nanoporous metal membrane comprises gold.

34. The fuel cell according to claim 31, wherein said plating layer comprises at least one precious metal.

35. The fuel cell according to claim 31, wherein said plating layer comprises platinum.

36. The fuel cell according to claim 31, wherein said plating layer comprises at least one member selected from the group consisting of platinum, iridium, rhodium, ruthenium, palladium, cobalt and silver.

37. The fuel cell according to claim 31, wherein said plating layer has a loading density of less than about 0.1 mg/cm².

38. The fuel cell according to claim 31, wherein said plating layer has a loading density of less than about 0.05 mg/cm².

39. The fuel cell according to claim 31, wherein said plating layer has a loading density of less than about 0.025 mg/cm².

40. The fuel cell according to claim 31, wherein said plating layer has a loading density of about 0.005 mg/cm².

41. A method which comprises:
freely supporting at least a portion of a nanoporous metal membrane on a metal plating solution comprising at least one plating metal; and
contacting said metal plating solution with a reducing agent, thereby plating at least a portion of said nanoporous metal membrane with said at least one plating metal.

42. The method according to claim 41, wherein said reducing agent is hydrazine.

43. The method according to claim 41, wherein said at least one plating metal is selected from the group consisting of platinum, iridium, rhodium, ruthenium, palladium, cobalt, silver and combinations thereof.

44. The method according to claim 41, wherein said metal plating solution comprises Na₂Pt(OH)₆.

45. The method according to claim 44, wherein said metal plating solution comprises about 2 g/l to about 20 g/l of Na₂Pt(OH)₆.

46. The method according to claim 41, wherein said nanoporous metal membrane comprises gold.

47. The method according to claim 41, wherein said metal plating solution is contacted with a vapor phase reducing agent.

48. The method according to claim 41, wherein said metal plating solution comprises at least two plating metals.

49. The method according to claim 41, wherein said method further comprises contacting a portion of said nanoporous metal membrane with at least one thiol prior to freely supporting at least a portion of said nanoporous metal membrane on a metal plating solution.

50. The method according to claim 49, wherein said thiol is CH₃(CH₂)₁₁—SH or CH₃(CH₂)₁₈—SH or combinations thereof.

51. The method according to claim 41, wherein the surface of said nanoporous metal membrane is plated with said at least one plating metal substantially continuously.

52. The method according to claim 41, wherein said nanoporous membrane is entirely freely supported on said metal plating solution.

53. A method which comprises:
contacting a nanoporous metal membrane with a metal plating solution comprising at least one plating metal; and
contacting said metal plating solution with a vapor phase reducing agent, thereby plating at least a portion of said nanoporous metal membrane with said at least one plating metal.

54. The method according to claim 53, wherein said reducing agent is hydrazine.

55. The method according to claim 53, wherein said at least one plating metal is selected from the group consisting of platinum, iridium, rhodium, ruthenium, palladium, cobalt, silver and combinations thereof.

56. The method according to claim 53, wherein said metal plating solution comprises Na₂Pt(OH)₆.

57. The method according to claim 56, wherein said metal plating solution comprises about 2 g/l to about 20 g/l of Na₂Pt(OH)₆.

58. The method according to claim 53, wherein said nanoporous metal membrane comprises gold.

59. The method according to claim 53, wherein the surface of said nanoporous metal membrane is plated with said at least one plating metal substantially continuously.

60. The method according to claim 53, wherein said metal plating solution comprises at least two plating metals.

61. The method according to claim 53, wherein said method further comprises contacting a portion of said nanoporous metal membrane with at least one thiol prior to contacting said nanoporous metal membrane with a metal plating solution.

62. The method according to claim 61, wherein said thiol is CH₃(CH₂)₁₁—SH, CH₃(CH₂)₁₈—SH or combinations thereof.

63. The method according to claim 53, wherein at least a portion of said nanoporous metal membrane is freely supported on said metal plating solution.

64. The method according to claim 53, wherein said nanoporous membrane is entirely freely supported on said metal plating solution.
